(19) United States
(12) Patent Application Publication
(10) Pub. No.: US 2012/0306601 A1
(43) Pub. Date: Dec. 6, 2012

(54) ELECTROMAGNETIC MECHANISM AND MANUAL SWITCHGEAR OF ELECTROMAGNETIC MECHANISM

(75) Inventor: Taehyun Kim, Tokyo (JP)

(73) Assignee: MITSUBISHI ELECTRIC CORPORATION, Tokyo (JP)

(21) Appl. No.: 13/575,226

(22) PCT Filed: Mar. 14, 2011
(86) PCT No.: PCT/JP2011/001479

§ 371 Date: Jul. 25, 2012

(30) Foreign Application Priority Data
Mar. 31, 2010 (JP) 2010-081479

(51) Int. Cl. H01F 7/08; H01H 9/00

(52) U.S. Cl. 335/179; 335/229

(57) ABSTRACT

With a switchgear provided with an electromagnetic mechanism of the invention, a bolt rod is disposed for an opening spring whose load acts over an entire movable range of a moving core so as to receive a load of the opening spring in an expanding direction by the bolt rod. A load of the opening spring in the expanding direction is thus received by the bolt rod. The opening spring is compressed and expanded by rotating the bolt rod to be moved by the screw structure. Hence, in a case where maintenance is performed while maintaining a contact at an intermediate position between an opening position and a closing position, it becomes possible to perform a manual opening and closing operation at a lower speed than a de-energization operation while holding the contact at the intermediate position between the opening position and the closing position.

### TECHNICAL FIELD

The present invention relates to an electromagnetic mechanism applied to a switchgear used in a power transmission and distribution system and a power receiving system and configured to force a moving core to be displaced with respect to a fixed core by energization to an electromagnetic coil, and to a manual switchgear used to manually open and close an electromagnetic mechanism.

### BACKGROUND ART

In a switchgear that opens and closes a contact by a drive force of an electromagnetic mechanism, an opening spring and a pressure-contacting spring store energy while the switchgear is closed and a moving core formed of an electromagnet is attracted and attached to a fixed core by an attraction force generated by permanent magnets. In a case where the switchgear is operated manually, a de-energization operation is performed by moving a coupling mechanism coupled to the electromagnet using a handle so that the moving core is forced to move up to a point at which loads of the opening spring and the pressure-contacting spring become greater than the attraction force generated by the permanent magnets (see, for example, Patent Document 1).

### CITED LIST

### Patent Document

Patent Document 1: Japanese Patent No. 3763094

### SUMMARY OF THE INVENTION

### Problems to be Solved by the Invention

In a case where an opening operation is performed by moving the coupling mechanism coupled to the electromagnet using the handle so that the moving core is forced to move up to a point at which loads of the opening spring and the pressure-contacting spring become greater than the attraction force generated by the permanent magnets, the opening operation becomes a de-energization operation due to loads generated in the opening spring and the pressure-contacting spring because of the absence of a structure controlling the operation. In a case where maintenance is performed by maintaining the contact at an intermediate point between an opening position and a closing position, it is necessary to perform a manual opening and closing operation at a lower speed than the de-energization operation so that the contact can be held at the intermediate position between the opening position and the closing position.

The invention is devised to solve the problems as discussed above and has an object to obtain an electromagnetic mechanism capable of reducing a load acting on a manual switchgear during a low-speed opening and closing operation and a manual switchgear allowing a low-speed opening and closing operation to be performed manually using the electromagnetic mechanism.

### Means for Solving the Problems

A coupling rod coupled to a drive shaft of an electromagnet, a supporting point to which the coupling rod is coupled with a pin so that the coupling road is allowed to turn, and an opening spring coupled to the coupling rod are disposed in such a manner that a distance between the supporting point coupled to the coupling rod and a coupling point of the opening spring to the coupling rod is greater than a distance between the supporting point and a coupling point of the drive shaft of the electromagnet to the coupling rod.

A bolt rod is disposed for the opening spring whose load acts over an entire movable range of a moving core so as to receive a load of the opening spring in an expanding direction. Accordingly, a load of the opening spring in the expanding direction is received by the bolt rod. The opening spring is compressed and expanded by rotating the bolt rod to be moved by the screw structure.

### Advantage of the Invention

The components are disposed in such a manner that a distance between the supporting point coupled to the coupling rod and the coupling point of the opening spring to the coupling rod becomes greater than a distance between the supporting point and the coupling point of the drive shaft of the electromagnet to the coupling rod. Hence, a load required in a portion of the opening spring becomes smaller and a load of the manual switchgear disposed in the portion of the opening spring is reduced.

An end portion of the bolt rod of the manual switchgear is in contact with an opening spring shaft and loads generated in the opening spring and a pressure-contacting spring are received by the screw structure. Hence, a moving contact and the moving core are allowed to move at a low speed by preventing a de-energization operation. Consequently, a contact can be held at an intermediate position between an opening position and a closing position.

### BRIEF DESCRIPTION OF THE DRAWINGS

FIG. 1 is a cross section showing a closing state of a switchgear according to a first embodiment of the invention.

FIG. 2 is a cross section showing an opening state of a contact of the switchgear of FIG. 1.

FIG. 3 is across section of an electromagnetic mechanism to which a manual switchgear is attached when the switchgear is in a closing state.

FIG. 4 is a cross section of the electromagnetic mechanism to which the manual switchgear is attached when the switchgear is in an opening state.

FIG. 5 is a view of a latch mechanism of the manual switchgear when viewed from above in FIG. 3.

FIG. 6 is a view of an opening spring bearing when viewed from above in FIG. 3.

FIG. 7 is a view showing a positional relation to allow claws of the latch mechanism to penetrate through respective holes of an opening spring bearing.

FIG. 8 is a view showing a state where the claws of the latch mechanism hook the opening spring bearing.

FIG. 9 is across section of an electromagnetic mechanism to which a manual switchgear is attached when a switchgear according to a second embodiment of the invention is in a closing state.

FIG. 10 is a cross section of the electromagnetic mechanism to which the manual switchgear is attached when the switchgear according to the second embodiment of the invention is in an opening state.

FIG. 11 is a cross section of an electromagnetic mechanism to which a manual switchgear is attached when a switchgear according to a third embodiment of the invention is in a closing state.

### MODE FOR CARRYING OUT THE INVENTION

### First Embodiment

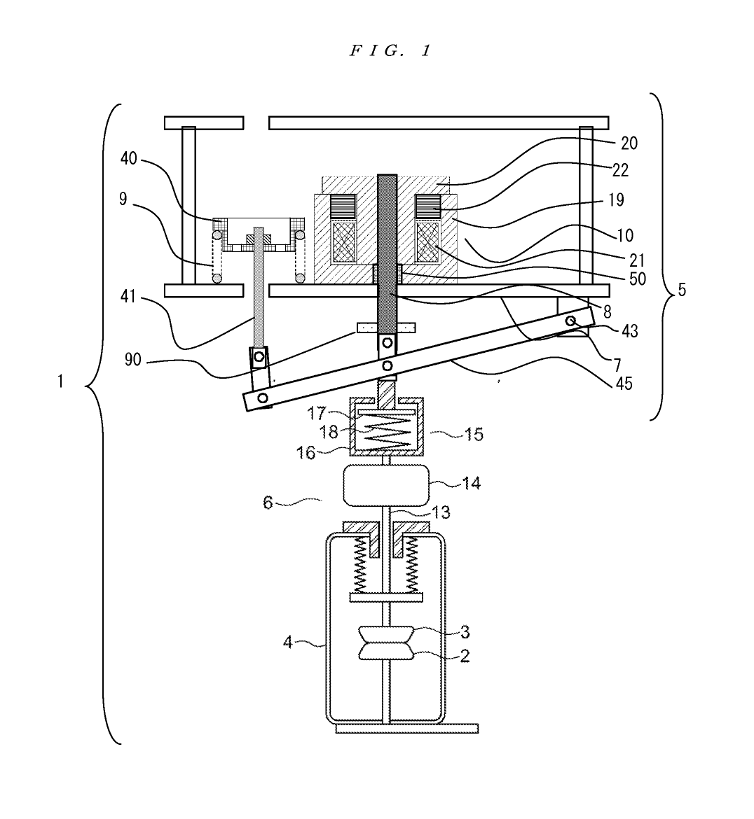

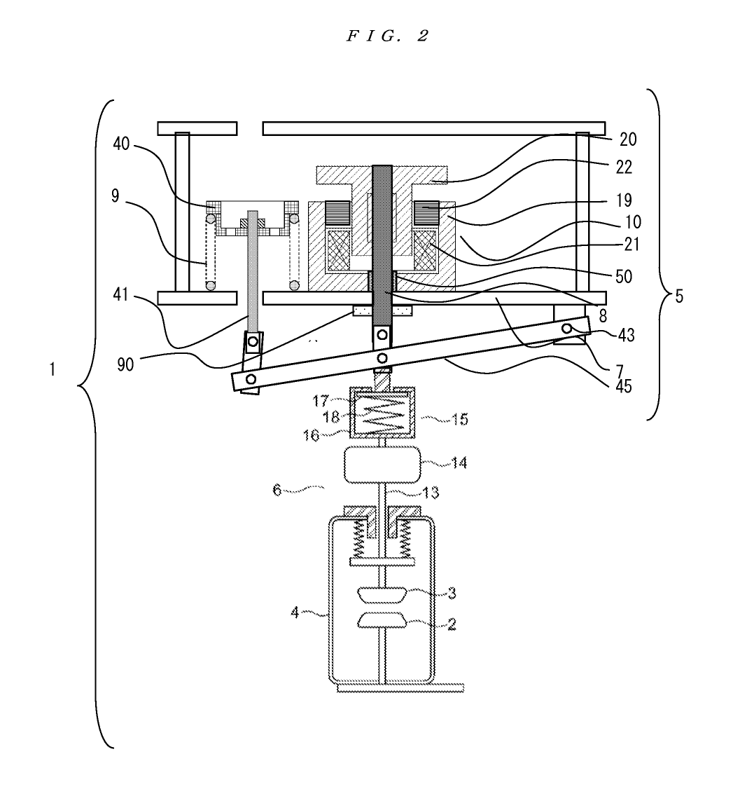

FIG. 1 is a cross section of a switchgear according to a first embodiment of the invention. Also, FIG. 2 is a cross section showing a state (opening state) where a contact of the switchgear of FIG. 1 is open. It should be noted that FIG. 1 is a view showing a state (closing state) where the contact of the switchgear 1 is closed. Referring to the drawings, the switchgear 1 includes a fixed contact 2, a moving contact 3 allowed to come into contact with and separate from the fixed contact 2, a vacuum valve 4 housing therein the fixed contact 2 and the moving contact 3, an opening spring 9 and an electromagnet 10 that force the moving contact 3 to be displaced, and an insulating rod 14 and a pressure-contacting device 15 disposed between the electromagnet 10 and the moving contact 3. Herein, the electromagnetic mechanism 5 means a mechanism including the electromagnet 10, the opening spring 9, and a coupling rod 45 and configured to drive the pressure-contacting device 15, the moving contact 3, and components in between.

The moving contact 3 comes into contact with and separates from the fixed contact 2 by displacement in an axial direction of the switchgear 1 (hereinafter, referred to simply as the axial direction). A contact of the switchgear 1 closes when the moving contact 3 comes into contact with the fixed contact 2 and opens when the moving contact 3 separates from the fixed contact 2.

The interior of the vacuum valve 4 is maintained under vacuum to enhance an arc-extinguishing performance between the fixed contact 2 and the moving contact 3. The moving contact 3 comes into contact with and separates from the fixed contact 2 within the vacuum valve 4. While the moving contact 3 is away from the fixed contact 2, a negative pressure is developed due to a vacuum within the vacuum valve 4 and a force to close the contact acts on the moving contact 3 with respect to the fixed contact 2.

The electromagnet 10 is supported on a plate-like supporting member 7. Also, the electromagnet 10 includes a drive shaft 8 connected to the moving contact 3 via the insulating rod 14 and the pressure-contacting device 15.

The drive shaft 8 penetrates through the supporting member 7 so as to be displaceable in the axial direction. Also, the drive shaft 8 is made of a material having low permeability (low-magnetic material) (for example, stainless).

The electromagnet 10 is provided with a fixed core 19 and a moving core 20 to which the drive shaft 8 is fixed and which is displaceable in the axial direction with respect to the fixed core 19.

The opening spring 9 is compressed between an opening spring bearing 40 and the supporting member 7 and generates an elastic repulsive force in the axial direction. An opening spring shaft 41 connected to the opening spring bearing 40 is connected to the coupling rod 45, which is attached to a supporting point 43 attached to the support member 7 and connected to the drive shaft 8, at a position more distant than the drive shaft 8 from the supporting point 43. With an elastic repulsive force of the opening spring 9 acting on the coupling rod 45, the drive shaft 8 is pushed in a direction in which the moving contact 3 separates from the fixed contact 2.

The drive shaft 8 is selectively displaced as the electromagnet 10 is controlled in either a direction (closing direction) in which the moving contact 3 comes into contact with the fixed contact 2 or a direction (opening direction) in which the moving contact 3 separates from the fixed contact 2.

The electromagnet 10 is electrically isolated from the moving contact 3 by the insulating rod 14.

The pressure-contacting device 15 includes a spring frame 16, a fall-off preventing plate 17 fixed to a tip end portion of the drive shaft 8 and disposed within the spring frame 16, and a pressure-contacting spring 18 connected between the spring frame 16 and the fall-off preventing plate 17 in a compressed state.

The drive shaft 8 together with the fall-off preventing plate 17 is displaceable in the axial direction with respect to the spring frame 16. The pressure-contacting spring 18 pushes the drive shaft 8 in a direction to separate from the movable contact 3. Displacement of the drive shaft 8 in a direction to separate from the movable contact 3 is regulated by engagement of the fall-off preventing plate 17 with the spring frame 16.

The moving core 20 is displaceable between a retracted position (FIG. 2) away from the fixed core 19 and an advanced position (FIG. 1) closer to the fixed core 19 than the retracted position. The retracted position is determined by a stopper 90 provided to the drive shaft 8. The moving contact 3 is away from the fixed contact 2 while the moving core 20 is at the retracted position and pressed against the fixed contact 2 while the moving core 20 is at the advanced position.

While the moving contact 3 is away from the fixed contact 2 (FIG. 2), upon displacement of the drive shaft 8 in the axial direction, the pressure-contacting device 15, the insulating rod 14, and the moving contact 3 are displaced together with the drive shaft 8. In this instance, the fall-off preventing plate 17 is engaged with the spring frame 16 due to a load of the pressure-contacting spring 18. Also, while the moving contact 3 is in contact with the fixed contact 2 (FIG. 1), the drive shaft 8 is further displaced in the closing direction with respect to the spring frame 16 against a load of the pressure-contacting spring 18. Accordingly, the pressure-contacting spring 18 is further compressed and the moving contact 3 is pressed against the fixed contact 2 with an elastic repulsive force of the pressure-contacting spring 18.

The electromagnet 10 includes the fixed core 19, the moving core 20 to which the drive shaft 8 is fixed and which is displaceable in the axial direction with respect to the fixed core 19, an electromagnetic coil 21 provided to the fixed core 19 and generating a field by energization, and permanent magnets 22 provided to the fixed core 19.

The drive shaft 8 penetrates through the fixed core 19 so as to be displaceable in the axial direction. In a case described herein, a bearing 50 is provided to the fixed core 19 and the drive shaft 8 penetrates through the bearing 50. A part of the fixed core 19 overlaps a region of the moving core 20 within a projection plane in the axial direction.

The permanent magnets 22 are provided to the fixed core 19 oppositely to the moving core 20. Each permanent magnet 22 has a north pole and a south pole (a pair of magnetic poles). Accordingly, the permanent magnets 22 generate a holding flux that holds the moving core 20 at the advanced position. In a case described herein, the north poles of the respective permanent magnets 22 oppose the moving core 20 and the south poles of the respective permanent magnets 22 are fixed to the fixed core 19.

The electromagnetic coil 21 surrounds a part of the moving core 20 within the projection plane in the axial direction. Accordingly, when energized, the electromagnetic coil 21 generates a flux passing through the fixed core 19 and the moving core 20. Also, a direction of the flux generated by the electromagnetic coil 21 can be reversed by switching an energizing direction to the electromagnetic coil 21. It should be noted that a center axis line of the electromagnetic coil 21 substantially coincides with an axial line of the switchgear 1.

The fixed core 19 and the moving core 20 each are a lamination body formed by laminating plural thin plates made of a magnetic material in a direction perpendicular to the axial direction.

A material of the fixed core 19 and the moving core 20 can be any high-permeable magnetic material and examples include but not limited to a steel material, electromagnetic soft iron, silicon steel, ferrite, and permalloy. Alternatively, the moving iron 20 may be, for example, a dust core formed of compacted iron powder.

An operation will now be described. As is shown in FIG. 2, during an open state in which the moving contact 3 is away from the fixed contact 2, the moving core 20 is displaced at the retracted position by a load of the opening spring 9. Upon energization to the electromagnetic coil 21, the moving core 20 is attracted to a first fixed core portion 26 and displaced from the retracted position toward the advanced position against the load of the opening spring 9. Consequently, the moving contact 3 is displaced toward the fixed contact 2.

Thereafter, when the moving contact 3 comes into contact with the fixed contact 2, displacement of the moving core 3 is stopped. The moving core 20, however, is displaced further and reaches the advanced position. Accordingly, as the pressure-contacting spring 18 is compressed, the moving contact 3 is pressed against the fixed contact 2 and a closing operation is completed (FIG. 1).

When the moving core 20 reaches the advanced position, the moving core 20 is held by the fixed core 19 by attraction due to a holding flux of the permanent magnets 22. The moving core 20 is thus held at the advanced position.

When the holding of the moving core 20 at the advanced position is cancelled, the electromagnetic coil 21 is energized in a direction opposite to the direction at the time of the closing operation. Upon energization to the electromagnetic coil 21, an attraction force between the moving core 20 and the fixed core 19 is lowered as a whole. Then, displacement of the moving core 20 from the advanced position to the retracted position is started by the respective loads of the opening spring 9 and the pressure-contacting spring 18. In this instance, the moving contact 3 is kept pressed against the fixed contact 2.

Thereafter, as the moving core 20 is further displaced toward the retracted position, the fall-off preventing plate 17 is engaged with the spring frame 16. As the moving core 20 is continuously displaced toward the retracted position, the moving contact 3 eventually separates from the fixed contact 2. The load of the opening spring 9 is greater than a force of the vacuum valve 4 forcing the moving contact 3 into contact with the fixed contact 2. Hence, the moving core 20 is displaced further and reaches the retracted position. Consequently, an opening operation is completed (FIG. 2).

As has been described, in the opening state (FIG. 2), the load of the opening spring 9 is greater than a load acting in the closing direction on the moving contact 3 to come into contact with the fixed contact 2 due to a negative pressure developed because the vacuum valve 4 is a vacuum container. An opening state can be therefore maintained in a stable manner. Also, even when a sum of a frictional force of a moving portion and the load of the opening spring 9 is greater than a load acting in the closing direction on the moving contact 3 to come into contact with the fixed contact 2 due to a negative pressure of the vacuum container as the vacuum valve 4, an opening state can be maintained in a reliable manner.

Meanwhile, in the closing state (FIG. 1), the permanent magnets 22 generate a holding flux that holds the moving core 20 at the advanced position. A load in the closing direction generated by the flux of the permanent magnets 22 acts on the moving core 20. Because this load is greater than a sum of the loads of the opening spring 9 and the pressure-contacting spring 18, the closing state can be maintained. Also, even when a sum of an attraction force and a frictional force of the moving part becomes equal to or greater than a sum of the loads of the opening spring 9 and the pressure-contacting spring 18, the closing state can be maintained in a stable manner.

The load of the opening spring 9 acts over an entire movable range of the moving core 20.

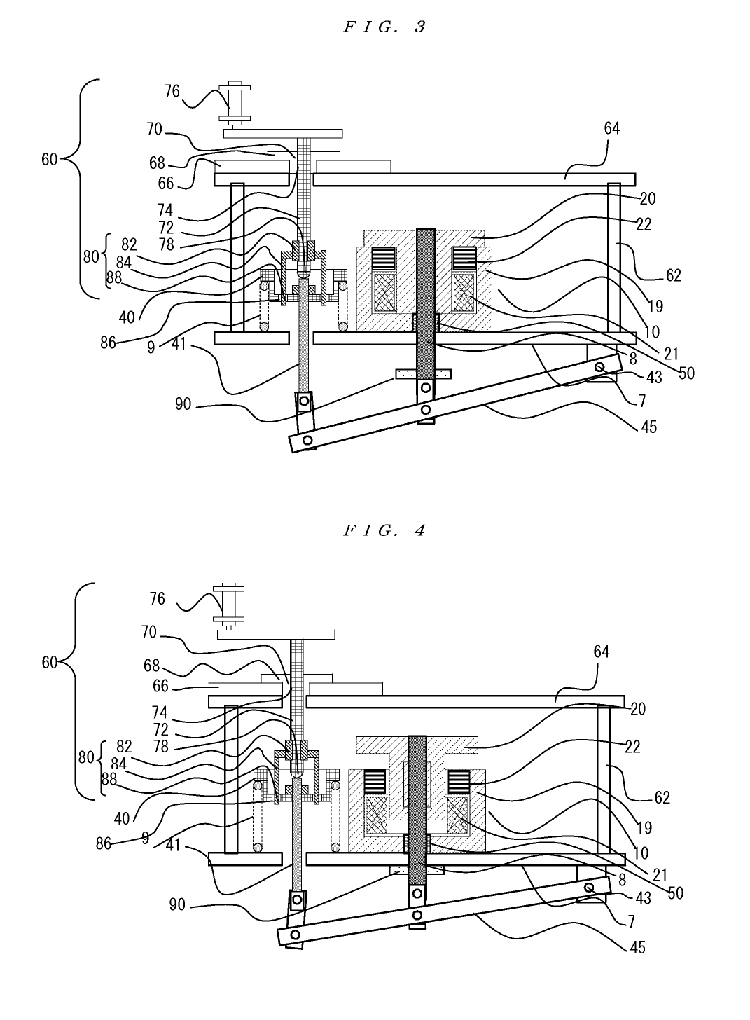

FIG. 3 is a cross section in a case where a manual switchgear 60 according to the first embodiment of the invention is applied. Also, FIG. 4 is a cross section showing a configuration in a state where the contact of the switchgear of FIG. 2 is opened (opening state). It should be noted that FIG. 3 is a cross section showing a configuration in a state (opening state) where the contact of the switchgear 1 of FIG. 1 is opened.

Referring to the drawings, there is a rod 62 connected to the supporting member 7 to which the electromagnet 10 and the opening spring 9 are attached, and a frame 64 is fixed to the rod 62. An attachment component 66 of the manual switchgear 60 is fastened to the frame 64. A guide 68 is fixed to the attachment component 66, and the guide 68 has a female screw portion 70. A male screw portion 74 of a bolt rod 72 as a drive rod is disposed in the female screw portion 70. As the bolt rod 72 rotates, the bolt rod 72 is allowed to move in contracting and expanding directions of the opening spring 9. A handle 76 is provided to the bolt rod 72 so that the bolt rod 72 is rotated manually. One end portion 78 of the bolt rod 72 is disposed so as to be in contact with an opening spring shaft 41. Regarding an expanding load of the opening spring 9, it is configured in such a manner that this load is received by a screw structure formed of the male screw portion 74 of the bolt rod 72 and the female screw portion 70. The bolt rod 72 is provided with a rotatable latch mechanism 80 coupled to the bolt rod 72 in a rotation direction thereof with a weak frictional force. The latch mechanism 80 has arms 84 extending from a slide portion 82 sliding on the bolt rod 72. It is structured in such a manner that the arms 84 penetrate through respective holes 86 provided to the opening spring bearing 40 in a state where the end portion 78 of the bolt rod 72 is in contact with the opening spring shaft 41. Claws 88 that hook the opening spring bearing 40 are provided at tip ends of the respective arm portions 84 of the latch mechanism 80.

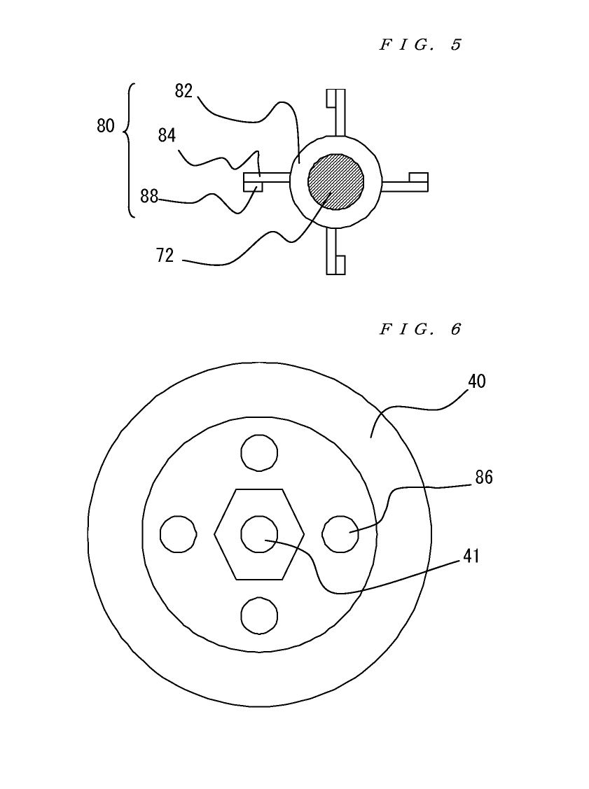

FIG. 5 is a view of the bolt rod 72 and the latch mechanism 80 according to the first embodiment of the invention when viewed from above in FIG. 3. FIG. 6 is a view of the opening spring bearing 40 and the opening spring shaft 41 according to the first embodiment of the invention when viewed from above in FIG. 3.

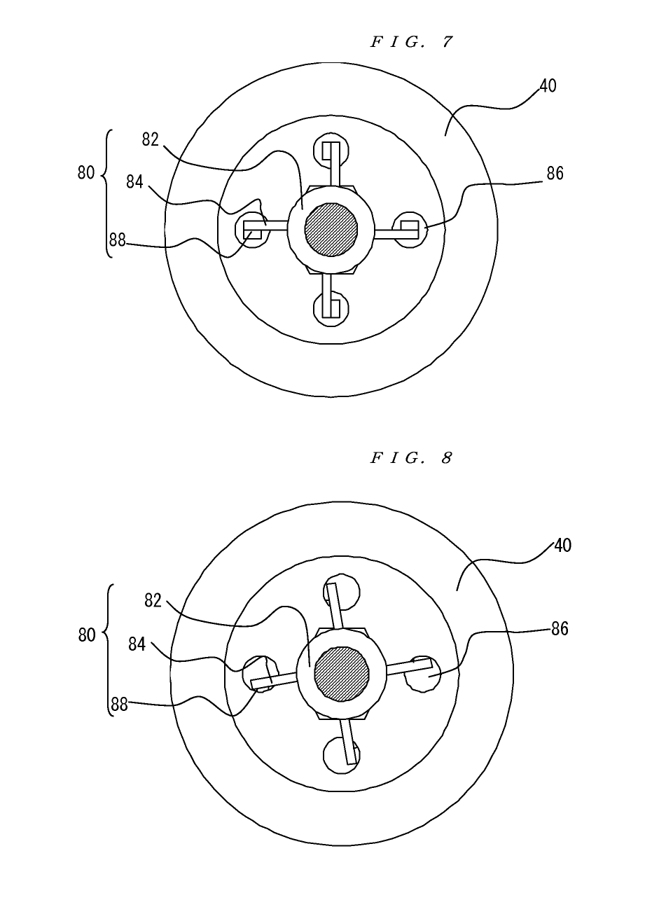

FIG. 7 and FIG. 8 are views used to describe an operation according to the first embodiment of the invention and each shows the latch mechanism 80, which is a major portion of the manual switchgear 60, and a major portion of the opening spring bearing 40, when viewed from above in FIG. 3.

A manual opening and closing operation will now be described. In an opening operation, the switchgear 1 is initially in the closing state (FIG. 1) and the permanent magnets 22 generate a holding flux that holds the moving core 20 at the advanced position.

A load in the closing direction generated by the flux of the permanent magnets 22 acts on the moving core 20. Because this load is greater than a sum of the loads of the opening spring 9 and the pressure-contacting spring 18, the closing state is maintained. In order to manually open the contact from in the closing state, the manual switchgear 60 is attached (FIG. 3).

When the manual switchgear 60 is attached, a portion of the latch mechanism 80 where the claws 88 at the tip ends of the respective arms 84 are disposed is passed through the respective holes 86 of the opening spring bearing 40 to bring the end portion 78 of the bolt rod 72 into contact with the opening spring shaft 41 (FIG. 3 and FIG. 7).

The latch mechanism 80 is coupled to the bolt rod 72 with a weak frictional force and disposed in a rotatable manner. Because this is a manual opening operation, the bolt rod 72 is rotated with the handle 76 (in the first embodiment, right-hand screw and a counterclockwise direction in FIG. 7 and FIG. 8) so that the bolt rod 72 moves in a direction in which the opening spring 9 expands. Then, as is shown in FIG. 8, the claws 88 of the latch mechanism 80 are hooked onto the opening spring bearing 40 because the latch mechanism 80 is coupled to the bolt rod 72 with a weak frictional force. As the bolt rod 72 is rotated continuously, the opening spring bearing 40 being hooked onto the latch mechanism 80 moves together with the bolt rod 72 in the direction in which the opening spring 9 expands. In association with the movement of the opening spring bearing 40, the moving core 20 coupled to the opening spring bearing 40 via the opening spring shaft 41 and the coupling rod 45 starts to move in the opening direction.

When the moving core 20 has moved by a predetermined distance, a sum of the loads of the opening spring 9 and the pressure-contacting spring 18 becomes greater than the load generated by the permanent magnets 22 forcing the moving core 20 to move in the closing direction. Accordingly, the opening spring bearing 40 changes from a state where it is pulled by the latch mechanism 80 in the direction in which the opening spring 9 expands to a state where it pushes the bolt rod 72 from the end portion 78 via the opening spring shaft 41 coupled to the opening spring bearing 40.

The bolt rod 72 receives the loads generated in the opening spring 9 and the pressure-contacting spring 18 by the screw structure formed of the male screw portion 74 and the female screw portion 70. As the bolt rod 72 is moved further, the opening spring bearing 40 starts to move at a low speed. Accordingly, the opening spring 9 applying a load over the entire movable range of the moving core 20 starts to expand at a low speed and the moving core 20 starts to move at a low speed. When the moving core 20 has moved to the opening position determined by the stopper 90 attached to the drive shaft 8, the opening operation is completed at a low speed.

In a closing operation, the switchgear 1 is initially in the opening state (FIG. 2). The opening spring 9 has expanded and the opening state is maintained with the moving core 20 staying at the opening position determined by the stopper 90 attached to the drive shaft 8. In order to manually close the contact in the opening state, the manual switchgear 60 is attached (FIG. 4) in the same capacity as with the manual opening operation.

The latch mechanism 80 is coupled to the bolt rod 72 with a weak frictional force and disposed in a rotatable manner. Because this is a manual closing operation, the bolt rod 72 is rotated with the handle 76 so that the bolt rod 72 moves in a direction in which the opening spring 9 contracts.

Then, the end portion 78 of the bolt rod 72 presses the opening spring shaft 41 in the direction in which the opening spring 9 contracts. By pressing the opening spring shaft 41, the opening spring 9 is compressed via the opening spring bearing 40. Also, the moving core 20 coupled to the opening spring 9 via the coupling rod 45 moves in the closing direction, too.

Because the bolt rod 72 receives the loads generated in the opening spring 9 and the pressure-contacting spring 18 by the screw structure formed of the male screw portion 74 and the female screw portion 70, the bolt rod 72 is capable moving at a low speed. Hence, it becomes possible to perform the closing operation on the moving core 20 at a low speed by compressing the opening spring 9 at a low speed. When the moving core 20 has moved to the closing position at which the moving core 20 comes into contact with the iron core 19, the closing operation is completed at a low speed.

With the electromagnetic mechanism and the manual switchgear of the electromagnetic mechanism as above, holding of the opening state and the closing state is established by a balance between an attraction force of the permanent magnets 22 and the loads of the opening spring 9 and the pressure-contacting spring 18 in the movable range of the moving core 20. Hence, in a case where the moving core 20 moves at a low speed, it is sufficient to allow the moving core 20 to move in consideration of the attraction force of the permanent magnets 22 and the loads of the opening spring 9 and the pressure-contacting spring 18. Accordingly, the manual switchgear can be of a simple structure having a linear movement structure alone. It is not necessary for the manual switchgear 60 to achieve a complex operation to release a mechanical holding structure while holding the opening spring 9 not to open naturally and an opening operation can be achieved by a pulling operation alone. It thus becomes possible to achieve a low-speed opening and closing operation with a simple structure.

Also, the opening spring 9 is connected to the coupling rod 45, which is attached to the supporting point 43 attached to the supporting member 7 and connected to the drive shaft 8, at a position more distant than the drive shaft 8 from the supporting point 43. Hence, according to the principle of leverage, a load generated in a portion of the opening spring 9 becomes smaller and a movement distance thereof becomes longer than a load and a movement distance of a portion of the drive shaft B. Because a load generated in the portion of the opening spring 9 is small, strength required for the manual switchgear 60 can be reduced. Also, because the movement distance becomes longer, it becomes possible to enhance a degree of accuracy of a low-speed movement and a position during the movement.

Also, the end portion 78 of the bolt rod 72 is in contact with the opening spring shaft 41 and the bolt rod 72 receives loads generated in the opening spring 9 and the pressure-contacting spring 18 by the screw structure formed of the male screw portion 74 and the female screw portion 70. Hence, the bolt rod 72 can receive the load of the opening spring 9 acting over the entire movable range of the moving core 20 and the load of the pressure-contacting spring 18 acting in a part of the movable range of the moving core 20. The moving core 20 is therefore allowed to move at a low speed.

### Second Embodiment

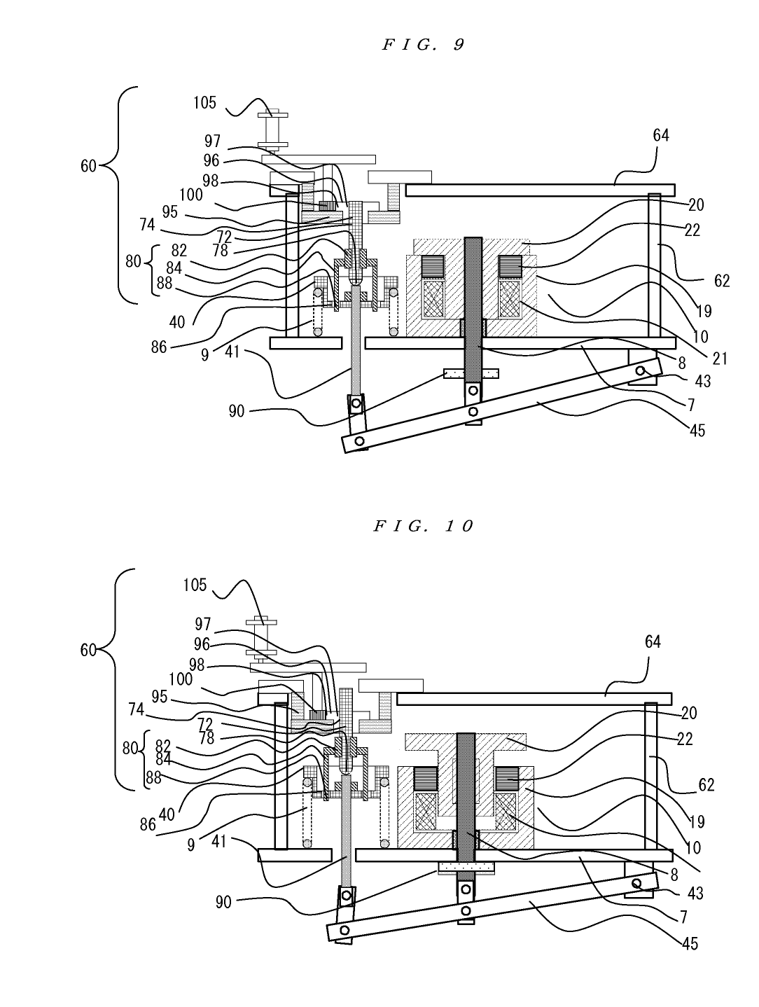

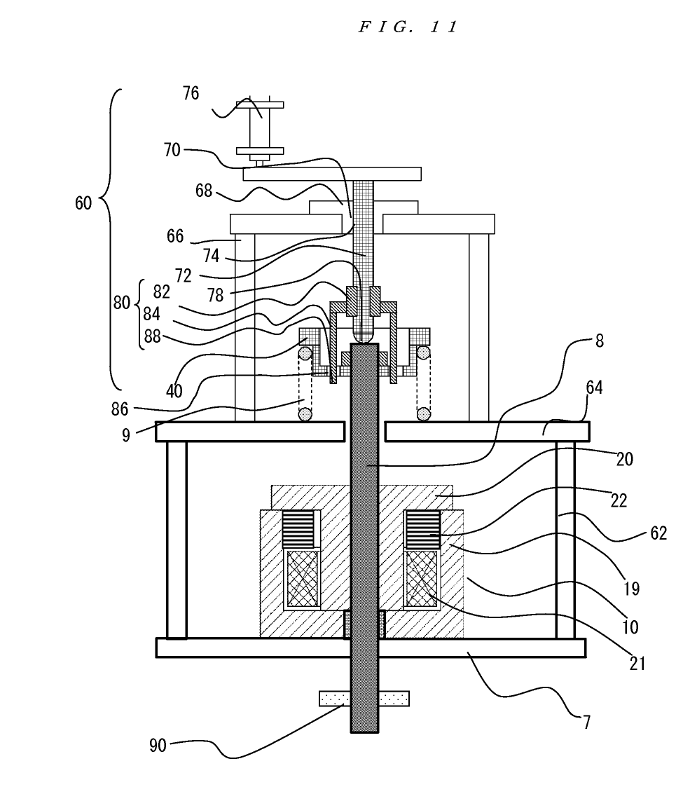

FIG. 9 is a cross section of an electromagnetic mechanism to which a manual switchgear is attached when a switchgear according to a second embodiment of the invention is in a closing state. FIG. 10 is a cross section of the electromagnetic mechanism to which the manual switchgear is attached while the switchgear is in an opening state. In the manual switchgear 60, a guide 96 provided with a gear portion 98 on an outer side thereof is attached to an attachment plate 95 in a rotatable manner. The guide 96 is provided with a female screw portion 97. A gear 100 meshed with the gear portion 98 of the guide 96 to rotate the guide 96 is attached to a handle 105.

With the manual switchgear 60 as above, because the guide 96 rotates to move the bolt rod 72, the handle 105 only rotates and does not move in a movement direction of the bolt rod 72. It thus becomes possible to save a space for a portion of the electromagnetic mechanism on an attachment side of the handle 105.

### Third Embodiment

FIG. 11 is a cross section of an electromagnetic mechanism to which a manual switchgear is attached when a switchgear according to a third embodiment of the invention is in a closing state. The opening spring 9 is connected directly to the drive shaft 8 via the opening spring bearing 40.

With the electromagnetic mechanism and the manual switchgear of the electromagnetic mechanism as above, holding of the opening state and the closing state is established by a balance between an attraction force of the permanent magnets 22 and the loads of the opening spring 9 and the pressure-contacting spring 18 in the movable range of the moving core 20. Hence, in a case where the moving core 20 moves at a low speed, it is sufficient to allow the moving core 20 to move in consideration of the attraction force of the permanent magnets 22 and the loads of the opening spring 9 and the pressure-contacting spring 18. Accordingly, the manual switchgear can be of a simple structure having a linear movement structure alone. It is not necessary for the manual switchgear 60 to achieve a complex operation to release a mechanical holding structure while holding the opening spring 9 not to open naturally and an opening operation can be achieved by a pulling operation alone. It thus becomes possible to achieve a low-speed opening and closing operation with a simple structure.

Also, the end portion 78 of the bolt rod 72 is in contact with the opening spring shaft 41 and the bolt rod 72 receives loads generated in the opening spring 9 and the pressure-contacting spring 18 by the screw structure formed of the male screw portion 74 and the female screw portion 70. Hence, the bolt rod 72 can receive the load of the opening spring 9 acting over the entire movable range of the moving core 20 and the load of the pressure-contacting spring 18 acting in a part of the movable range of the moving core 20. The moving core 20 is therefore allowed to move at a low speed.

### DESCRIPTION OF REFERENCE NUMERALS AND SIGNS

1: switchgear
5: electromagnetic mechanism
8: drive shaft
9: opening spring
10: electromagnet
19: fixed core
20: moving core
21: electromagnetic coil
22: permanent magnet
40: opening spring bearing
41: opening spring shaft
43: supporting point
45: coupling rod
70: female screw portion
72: bolt rod
74: male screw portion
78: end portion
80: latch mechanism
82: slide portion
84: arm
86: hole
88: claw

1. An electromagnetic mechanism, comprising:
a fixed core;
a moving core that advances and retracts with respect to the fixed core;
a permanent magnet that is fixed to the fixed core with one surface of a magnetic pole opposing the fixed core and the other surface of the magnetic pole opposing the moving core;
a shaft that is coupled to the moving core;
an electromagnet that is provided with an electromagnetic coil disposed so as to wind around the shaft;
a coupling rod that is coupled to the shaft of the electromagnet;
a supporting point to which the coupling rod is coupled with a pin so that the coupling rod is allowed to turn; and
an opening spring that is coupled to the coupling rod,
wherein
a distance between the supporting point coupled to the coupling rod and a coupling point of the opening spring to the coupling rod is greater than a distance between the supporting point and a coupling point of the shaft of the electromagnet to the coupling rod.

2. The electromagnetic mechanism according to claim 1, further comprising:
an opening spring bearing that receives a load of the opening spring; and
a hole provided to the opening spring bearing along a circumference about an axis line of the opening spring.

3. The electromagnetic mechanism according to claim 1, wherein
a manual switchgear having a drive rod disposed at a position of the coupling point of the opening spring to the coupling rod is attachable to the electromagnetic mechanism.

4. A manual switchgear of an electromagnetic mechanism to be attached to the electromagnetic mechanism according to claim 1, wherein
the drive rod of the manual switchgear is disposed at a position at which one end portion thereof receives a load of the opening spring in an expanding direction with the opening spring bearing that receives a load of the opening spring or a component connected to the opening spring bearing; and
the manual switchgear includes a male screw portion provided on an outer periphery of the drive rod and a guide provided with a female screw guiding the male screw portion of the drive rod.

5. The manual switchgear of the electromagnetic mechanism according to claim 4, further comprising:
a latch device attached to the drive rod in a rotatable manner;
an arm portion extending from the latch device; and
a claw attached to a tip end of the arm portion,
wherein the claw of the latch device penetrates through the hole of the opening spring bearing of the electromagnetic mechanism.

6. An electromagnetic mechanism to which a manual switchgear is to be attached, wherein
the electromagnetic mechanism comprises,
a fixed core,
a moving core that advances and retracts with respect to the fixed core,
a permanent magnet that is fixed to the fixed core with one surface of a magnetic pole opposing the fixed core and the other surface of the magnetic pole opposing the moving core,
a shaft that is coupled to the moving core,
an electromagnet that is provided with an electromagnetic coil disposed so as to wind around the shaft, and
an opening spring that is coupled to the shaft;
the manual switchgear having a drive rod disposed at a position of the shaft is attachable to the electromagnetic mechanism;
the drive rod of the manual switchgear is disposed at a position at which one end portion thereof receives a load of the opening spring in an expanding direction with an opening spring bearing that receives a load of the opening spring or a component connected to the opening spring bearing; and
the manual switchgear includes a male screw portion provided on an outer periphery of the drive rod and a guide provided with a female screw guiding the male screw portion of the drive rod.
